(19) United States
(12) Patent Application Publication
(10) Pub. No.: US 2013/0201143 A1
(43) Pub. Date: Aug. 8, 2013

(54) TOUCH SCREEN PANEL AND TOUCH SCREEN ASSEMBLY INCLUDING THE SAME

(71) Applicant: Jaeheung Han, Seoul (KR)

(72) Inventor: Jaeheung Han, Seoul (KR)

(73) Assignee: LG INNOTEK CO., LTD., Seoul (KR)

(21) Appl. No.: 13/879,060

(22) PCT Filed: Jul. 16, 2011
(86) PCT No.: PCT/KR2011/005255

§ 371 Date: Apr. 12, 2013

(30) Foreign Application Priority Data
Oct. 18, 2010 (KR) 10-2010-0101328

(51) Int. Cl. G06F 3/041

(52) U.S. Cl. CPC G06F 3/041
USPC 345/173

(57) ABSTRACT

The present invention relates to an optical touch screen, the screen including: a transparent substrate formed at one side with a first detection pattern; and a film layer formed with a second detection pattern, wherein the first detection pattern and the second detection pattern are facing each other.

### TECHNICAL FIELD

The teachings in accordance with the exemplary embodiments of this invention relate generally to a touch screen panel, and more particularly to a structure-simplified touch screen panel and a fabricating method of the structure-simplified touch screen panel.

### BACKGROUND ART

A touch screen panel or touch panel is a display which can detect the location of touches within the display area, usually performed either with the human hand or a stylus. This allows the display to be used as an input device capable of performing an overall control of electronic devices including a display screen control.

To this end, the touch screen panel is disposed at a front of an image display device to convert a position directly contacted by hands or an object to an electrical signal, whereby instruction information selected by the contact position is received as an input signal.

The touch screen panel can replace a separate input device operated by being connected to the image display device such as a key board or a mouse, such that its use scope is gradually expanded these days.

Technically speaking, commonly used touch screen panels employ resistive, capacitive, surface acoustic wave (SAW), electromagnetic, vector force and optical touch modes. Among these types of touch screens, the capacitance type touch screen panel is increased in its application scope due to the fact that it adopts capacity changes generated from the combination of static electricity between arranged transparent electrodes and a human body, so as to detect coordinates of the contact position through a generated induced current, where the contacted position is converted to an electrical signal.

Now, a conventional touch screen panel will be briefly described with reference to FIG. 1.

Referring to FIG. 1, the touch screen panel includes a first adhesive layer (21) formed on a film layer (11) formed with a first detection pattern, a film layer (12) formed on a second detection pattern formed on the first adhesive layer (21), a second adhesive layer (22) formed on the film layer (12) formed with the second detection pattern, and a transparent substrate (30) formed on the second adhesive layer (22). The conventional touch screen panel suffers from disadvantages in that manufacturing cost increases due to several stacking processes, a distance between the transparent substrate (30) and the first detection pattern (11) is too far apart to deteriorate sensitivity.

Now, another conventional touch screen panel will be described briefly with reference to FIG. 2.

Referring to FIG. 2, the touch screen panel includes a first adhesive layer (51) formed on a PET (Polyethylene Terephthalate) film layer (40) for reinforcing strength of the panel, an ITO (Indium Tin Oxide) glass (60) formed on the first adhesive layer (51), a second adhesive layer (52) formed on the ITO glass (60), and a transparent substrate (70) formed on the second adhesive layer (52).

The another conventional touch screen panel also suffers from disadvantages in that processes are complicated due to formation of first and second detection patterns for x and y axes on both sides of the ITO glass (60) to thereby increase defect rates. Furthermore, as in the conventional touch screen panel according to FIG. 1, said another conventional touch screen panel also suffers from disadvantages of increased manufacturing cost due to several stacking processes.

### DISCLOSURE OF INVENTION

### Technical Problem

The present invention is directed to solve the aforementioned disadvantages or shortcomings, and the present invention is to provide a touch screen panel capable of simplifying stacked structure to simplify the manufacturing processes and to slim the touch screen panel, and to increase sensitivity, and a fabricating method of the structure-simplified touch screen panel.

Technical problems to be solved by the present invention are not restricted to the above-mentioned, and any other technical problems not mentioned so far will be clearly appreciated from the following description by skilled in the art.

### Solution to Problem

An object of the invention is to solve at least one or more of the above problems and/or disadvantages in whole or in part and to provide at least the advantages described hereinafter. In order to achieve at least the above objects, in whole or in part, and in accordance with the purposes of the invention, as embodied and broadly described, and in one general aspect of the present invention, there is provided a touch screen panel, the panel comprising: a transparent substrate formed at one side with a first detection pattern; a film layer formed with a second detection pattern; and an optical transparent adhesive layer adhering the transparent substrate and the film layer by oppositely arranging each detection formation surface of the transparent substrate and the film layer.

Preferably, the transparent substrate is a reinforced glass or a reinforced plastic.

Preferably, the film layer is made of PET (Polyethylene Terephthalate).

Preferably, the first detection pattern is formed by deposition method.

Preferably, the second detection pattern is formed by deposition method.

Preferably, the first and second detection patterns are formed with transparent electrode material.

Preferably, the optical transparent adhesive layer is an optical transparent adhesive film or a photosensitive resin.

Preferably, each of extension directions of the first and second detection patterns is perpendicularly arranged.

In another general aspect of the present invention, there is provided a touch screen panel, the panel comprising: a transparent substrate formed at one side with a detection pattern; a film layer; and an optical transparent adhesive layer in which a detection pattern formation surface of the transparent substrate is arranged to face the film layer.

Preferably, the detection pattern is formed by deposition method.

Preferably, the detection patterns are formed with transparent electrode material.

Preferably, the optical transparent adhesive layer is made of optical transparent adhesive film or photosensitive resin.

Preferably, the transparent substrate is a reinforced glass or a reinforced plastic.

Preferably, the film layer is made of PET (Polyethylene Terephthalate).

In still another general aspect of the present invention, there is provided a touch screen panel, the panel comprising: a transparent substrate; a film layer formed at one side with a detection pattern; and an optical transparent adhesive layer in which a surface formed with the detection pattern of the film layer is arranged to face the transparent substrate.

Preferably, the detection pattern is formed by deposition method.

Preferably, the detection pattern is formed with transparent electrode material.

Preferably, the optical transparent adhesive layer is made of optical transparent adhesive film or photosensitive resin.

Preferably, the film layer is made of PET (Polyethylene Terephthalate).

In still another general aspect of the present invention, there is provided a fabricating method for the touch screen panel, the method comprising: forming a first detection pattern on a transparent substrate; forming a second detection pattern on a film layer; and forming an optical transparent adhesive layer by oppositely facing each detection pattern formation surface of the transparent substrate and the film layer.

### Advantageous Effects of Invention

The touch screen panel and a fabricating method for the touch screen panel according to the present invention have advantageous effects in that a stacking structure is simplified to simplify manufacturing processes and to slim the touch screen panel, whereby sensitivity of the touch screen panel can be enhanced.

### BRIEF DESCRIPTION OF DRAWINGS

The teachings of the present invention can be readily understood by considering the following detailed description in conjunction with the accompanying drawings, in which:

FIG. 1 is a cross-sectional view of a touch screen panel according to prior art;

FIG. 2 is a cross-sectional view of a touch screen panel formed by using ITO glass according to prior art;

FIG. 3 is a cross-sectional view of a touch screen panel according to an exemplary embodiment of the present invention;

FIG. 4 is a mimetic diagram of a touch screen panel according to an exemplary embodiment of the present invention;

FIG. 5 is a plan view illustrating an arrangement of detection patterns according to an exemplary embodiment of the present invention;

### BEST MODE FOR CARRYING OUT THE INVENTION

The following description is not intended to limit the invention to the form disclosed herein. Consequently, variations and modifications commensurate with the following teachings, and skill and knowledge of the relevant art are within the scope of the present invention. The embodiments described herein are further intended to explain modes known of practicing the invention and to enable others skilled in the art to utilize the invention in such, or other embodiments and with various modifications required by the particular application(s) or use(s) of the present invention.

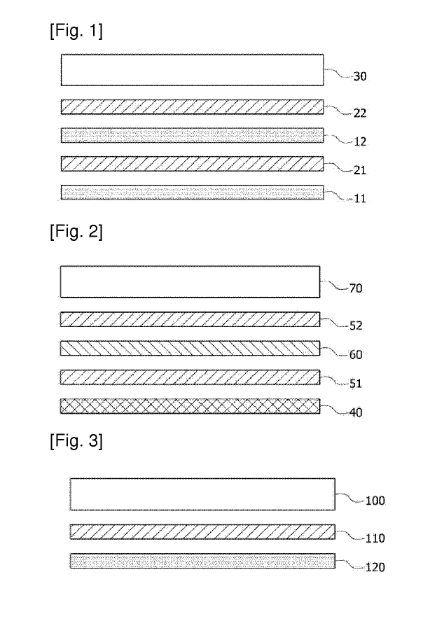

The disclosed embodiments and advantages thereof are best understood by referring to FIGS. 1-5 of the drawings, like numerals being used for like and corresponding parts of the various drawings. Other features and advantages of the disclosed embodiments will be or will become apparent to one of ordinary skill in the art upon examination of the following figures and detailed description.

It is intended that all such additional features and advantages be included within the scope of the disclosed embodiments, and protected by the accompanying drawings. Further, the illustrated figures are only exemplary and not intended to assert or imply any limitation with regard to the environment, architecture, or process in which different embodiments may be implemented. Accordingly, the described aspect is intended to embrace all such alterations, modifications, and variations that fall within the scope and novel idea of the present invention.

It will be understood that the terms “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. That is, the terms “including”, “includes”, “having”, “has”, “with”, or variants thereof are used in the detailed description and/or the claims to denote non-exhaustive inclusion in a manner similar to the term “comprising”.

Furthermore, “exemplary” is merely meant to mean an example, rather than the best. It is also to be appreciated that features, layers and/or elements depicted herein are illustrated with particular dimensions and/or orientations relative to one another for purposes of simplicity and ease of understanding, and that the actual dimensions and/or orientations may differ substantially from that illustrated. That is, in the drawings, the size and relative sizes of layers, regions and/or other elements may be exaggerated or reduced for clarity. Explanations that duplicate one another will be omitted.

As used in the specification and in the claims, the singular form of “a”, “an”, and “the” include plural referents unless the context clearly dictates otherwise. It will be understood that, although the terms “first”, “second”, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of example embodiments.

Now, the present invention will be described in detail with reference to the accompanying drawings.

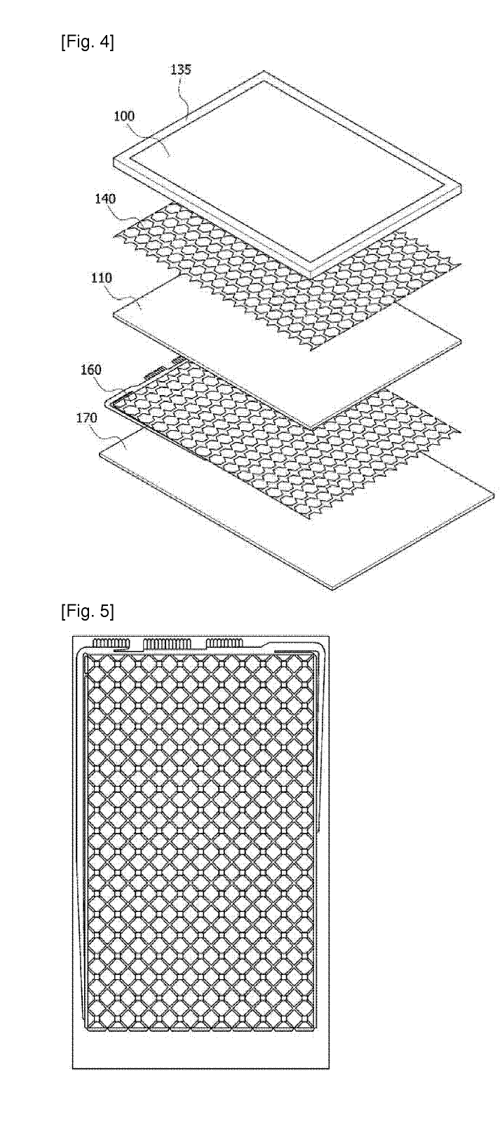

FIG. 3 is a cross-sectional view of a touch screen panel according to an exemplary embodiment of the present invention, and FIG. 4 is a mimetic diagram of a touch screen panel according to an exemplary embodiment of the present invention.

Referring to FIGS. 3 and 4, a touch screen panel according to an exemplary embodiment of the present invention includes a transparent substrate (100) formed at one side with a first detection pattern (140); a film layer (120) formed with a second detection pattern (160); and an optical transparent adhesive layer (110) adhering the transparent substrate (100) and the film layer (120) by oppositely arranging each detection formation surface of the transparent substrate (100) and the film layer (120).

The transparent substrate may be a reinforced glass or a reinforced plastic, and the film layer may be made of PET (Polyethylene Terephthalate). Furthermore, the optical transparent adhesive layer may be an optical transparent adhesive film or a photosensitive resin.

The first and second detection patterns (140, 160) and the film layer (110) may be formed with transparent material to allow light emitted from a display panel (not shown) disposed at a bottom surface of the touch screen panel to pass the touch screen panel.

That is, the first and second detection patterns (140, 160) are formed with transparent electrode material such as ITO (Indium Tin Oxide), and the PET (Polyethylene Terephthalate) forming the film layer (120) is also transparent material.

The first and second detection patterns (140, 160) are respectively formed on the transparent substrate (100) and the film layer (120) by deposition method and processed thereafter. That is, the first and second detection patterns (140, 160) are respectively formed on the transparent substrate (100) and the film layer (120) by deposition method and processed thereafter, and each of extension directions of the first and second detection patterns (140, 160) is perpendicularly arranged.

That is, if any one pattern is extended to an x-direction, the other pattern is extended to a y-direction.

### MODE FOR THE INVENTION

FIG. 5 is a plan view illustrating an arrangement of detection patterns according to an exemplary embodiment of the present invention;

Referring to FIG. 5, the first detection pattern (140) is formed at one side of the transparent substrate (100). For example, the first detection pattern (140) may be formed in a regular systematic diamond pattern on an upper surface of the transparent substrate (100). The form of the first detection pattern (140) is not limited to the diamond shape, but may be variably formed in other shapes as necessary.

The second detection pattern (160) may be formed on the film layer (170) but is alternatively arranged with the first detection pattern (140) to minimize overlap with the first detection pattern (140) on a plan surface. For example, the first and second detection patterns (140, 160) may be arranged in net shapes as shown in FIG. 5. Furthermore, the first and second detection patterns (140, 160) may be formed with metal electrodes (not shown) for electrical connection with metal patterns (not shown) on a column base.

The metal patterns (not shown) of the first and second detection patterns (140, 160) may be formed at peripheries of the transparent substrate and the film layer. Meanwhile, a touch screen panel according to another exemplary embodiment of the present invention may include: a transparent substrate (100) formed at one side with a detection pattern; a film layer (120); and an optical transparent adhesive layer (110) in which a detection pattern formation surface of the transparent substrate is arranged to face the film layer.

Alternatively, a touch screen panel according to still another exemplary embodiment of the present invention may include: a transparent substrate (100); a film layer (120) formed at one side with a detection pattern; and an optical transparent adhesive layer (110) in which a surface formed with the detection pattern of the film layer (120) is arranged to face the transparent substrate.

The touch screen panel in the present exemplary embodiment of the present invention may be different from that of the first exemplary embodiment, however, explanation on the method for forming a detection pattern and optical transparent adhesive layer are same as that of the first exemplary embodiment, so that there is no more redundant explanation thereto.

The touch screen panel may be adequate for electromagnetic touch screen panel, but it is not limited thereto but may be applicable to capacitive touch screen panel.

A fabricating method for the touch screen panel may include: forming a first detection pattern (140) on a transparent substrate (100); forming a second detection pattern (160) on a film layer (120); and forming an optical transparent adhesive layer by oppositely facing each detection pattern formation surface of the transparent substrate (100) and the film layer (120) .

The previous description of the present invention is provided to enable any person skilled in the art to make or use the invention. Various modifications to the invention will be readily apparent to those skilled in the art, and the generic principles defined herein may be applied to other variations without departing from the spirit or scope of the invention. Thus, the invention is not intended to limit the examples described herein, but is to be accorded the widest scope consistent with the principles and novel features disclosed herein.

### INDUSTRIAL APPLICABILITY

The present invention has an industrial applicability in that a stacking structure is simplified to simplify manufacturing processes and to slim the touch screen panel, whereby sensitivity of the touch screen panel can be enhanced.

1. A touch screen panel, the panel comprising:
a transparent substrate formed at one side with a first detection pattern; and
a film layer formed with a second detection pattern
wherein the first detection pattern and the second detection pattern are facing each other.

2. The touch screen panel of claim 1, wherein the transparent substrate is a reinforced glass or a reinforced plastic.

3. The touch screen panel of claim 1, wherein the film layer is made of PET (Polyethylene Terephthalate).

4. The touch screen panel of claim 1, wherein the first detection pattern is formed by deposition method.

5. The touch screen panel of claim 1, wherein the second detection pattern is formed by deposition method.

6. The touch screen panel of claim 1, wherein the first and second detection patterns are formed with transparent electrode materials.

7. The touch screen panel of claim 1, wherein the optical transparent adhesive layer is an optical transparent adhesive film or a photosensitive resin.

8. The touch screen panel of claim 1, wherein each of extension directions of the first and second detection patterns is perpendicularly arranged.

9-20. (canceled)

21. The touch screen panel of claim 1, further comprising an optical transparent adhesive layer adhering the transparent substrate and the film layer.

22. The touch screen panel of claim 21, wherein the first detection pattern directly contacts the optical transparent adhesive layer.

23. The touch screen panel of claim 22, wherein the second detection pattern directly contacts the optical transparent adhesive layer.
